(19) United States
(12) Patent Application Publication
(10) Pub. No.: US 2022/0350351 A1
(43) Pub. Date: Nov. 3, 2022

(54) MEASUREMENT AND USE OF SHAFT TORQUE IN A CONTROL VALVE

(71) Applicant: FISHER CONTROLS INTERNATIONAL LLC, Marshalltown, IA (US)

(72) Inventors: Joseph Frank DeMonte, Marshalltown, IA (US); William Sean Raymond, Marshalltown, IA (US)

(21) Appl. No.: 17/244,622

(22) Filed: Apr. 29, 2021

(51) Int. Cl. G05D 17/02; G05B 15/02; F16K 37/00

(52) U.S. Cl. CPC G05D 17/02; G05B 15/02; F16K 37/0041

(57) ABSTRACT

Described techniques provide direct measurement of shaft torque in control valve assemblies. The measured torque can be utilized to analyze the performance or health of the control valve. The described techniques utilize a direct measurement of shaft torque, providing a more accurate and precise measurement than an indirect or proxy measurement.

### TECHNICAL FIELD

The present disclosure generally relates to detecting shaft torque in control valve assemblies, and, more specifically, to techniques for measuring the shaft torque and making the measurement available to a valve controller.

### BACKGROUND

Distributed process control systems, such as distributed or scalable process control systems like those used in power generation, chemical, petroleum, or other processes, typically include one or more process controllers communicatively coupled to each other, to at least one host or operator workstation via a process control network, and to one or more instrumentation or field devices via analog, digital, or combined analog/digital buses.

The field devices perform functions within the process or plant such as opening or closing valves, switching devices on and off, and measuring process parameters. Example field devices include valves, valve positioners, switches, and transmitters (e.g., devices including sensors for measuring temperature, pressure, or flow rate; and transmitters for transmitting the sensed temperatures, pressures, and flow rates).

The process controllers, which are typically located within the plant environment, receive signals indicative of process measurements made by the field devices (or other information pertaining to the field devices) and execute a controller application that runs, for example, different control modules which make process control decisions, generate control signals based on the received information, and coordinate with the control modules or blocks being implemented in smart field devices (e.g., HART®, WirelessHART®, and FOUNDATION® Fieldbus field devices).

Execution of the control modules causes the process controllers to send the control signals over the communication links or signal paths to the field devices, to thereby control the operation of at least a portion of the process plant or system (e.g., to control at least a portion of one or more industrial processes running or executing within the plant or system). For example, a first set of controller(s) and field devices may control a first portion of a process being controlled by the process plant or system, and a second set of controller(s) and field devices may control a second portion of the process.

Input/output (I/O) cards (sometimes called “I/O devices” or “I/O modules”), which are also typically located within the plant environment, typically are communicatively disposed between a controller and one or more field devices, enabling communications there between (e.g., by converting electrical signals into digital values and vice versa). Typically, an I/O card functions as an intermediary node between a process controller and one or more field devices inputs or outputs configured for the same communication protocol or protocols as those utilized by the I/O card. Specifically, field device inputs and outputs are typically configured for either analog or discrete communications. In order to communicate with a field device, a controller generally needs an I/O card configured for the same type of input or output utilized by the field device. That is, for a field device configured to receive analog control output signals (e.g., a 4-20 mA signal), the controller needs an analog output (AO) I/O card to transmit the appropriate analog control output signal; and for a field device configured to transmit measurements or other information via an analog signal, the controller typically needs an analog input (AI) card to receive the transmitted information. Similarly, for a field device configured to receive discrete control output signals, the controller needs a discrete output (DO) I/O card to transmit the appropriate discrete control output signal; and for a field device configured to transmit information via a discrete control input signal, the controller needs a discrete input (DI) I/O card.

As utilized herein, field devices, controllers, and I/O devices are generally referred to as “process control devices,” and are generally located, disposed, or installed in a field environment of a process control system or plant. The network formed by one or more controllers, the field devices communicatively connected to the one or more controllers, and the intermediary nodes facilitating communication between the controllers and field devices may be referred to as an “I/O network” or “I/O subsystem.”

Information from the I/O network(s) may be made available over a data highway or communication network (the “process control network”) to one or more other hardware devices, such as operator workstations, personal computers or computing devices, handheld devices, data historians, report generators, centralized databases, or other centralized administrative computing devices that are typically placed in control rooms or other locations away from the harsher field environment of the plant, e.g., in a back-end environment of the process plant.

The information communicated over the process control network enables an operator or a maintenance person to perform desired functions with respect to the process via one or more hardware devices connected to the network. These hardware devices may run applications that enable an operator to, e.g., change settings of the process control routine(s), modify the operation of the control modules within the process controllers or the smart field devices, view the current state of the process or status of particular devices within the process plant, view alarms generated by field devices and process controllers, simulate the operation of the process for the purpose of training personnel or testing the process control software, diagnose problems or hardware failures within the process plant, etc. The process control network or data highway utilized by the hardware devices, controllers, and field devices may include a wired communication path, a wireless communication path, or a combination of wired and wireless communication paths.

As an example, the DeltaV™ control system and Ovation™ distributed control system (DCS) sold by Emerson each includes multiple applications stored within and executed by different devices located at diverse places within a process plant. A configuration application, which resides in one or more workstations or computing devices in a back-end environment of a process control system or plant, enables users to create or change process control modules and download these process control modules via a data highway to dedicated distributed controllers. Typically, these control modules are made up of communicatively interconnected function blocks, which are objects in an object-oriented programming protocol that (i) perform functions within the control scheme based on inputs thereto and (ii) provide outputs to other function blocks within the control scheme. The configuration application may also allow a configuration designer to create or change operator interfaces, which are used by a viewing application to display data to an operator and to enable the operator to change settings, such as set points, within the process control routines.

Each dedicated process controller (and, in some cases, one or more field devices) stores and executes a respective controller application that runs the control modules assigned and downloaded thereto to implement actual process control functionality. The viewing applications, which may be executed on one or more operator workstations (or on one or more remote computing devices in communicative connection with the operator workstations and the data highway), receive data from the controller application via the data highway and display this data to process control system designers, operators, or users using the user interfaces, and may provide any of a number of different views, such as an operator's view, an engineer's view, a technician's view, etc. A data historian application is typically stored in and executed by a data historian device that collects and stores some or all of the data provided across the data highway while a configuration database application may run in a still further computer attached to the data highway to store the current process control routine configuration and data associated therewith. Alternatively, the configuration database may be located in the same workstation as the configuration application.

In addition to process controllers, I/O cards, and field devices, a typical process control system includes many other supporting devices which are also necessary for, or related to, process operation. These additional devices include, for example, power supply equipment, power generation and distribution equipment, rotating equipment such as turbines, etc., which are located at numerous places in a typical plant.

Note, this background description provides context to facilitate understanding and appreciating the detailed description below. Work of the presently named inventors, to the extent described in this background section (as well as aspects of the background description that may not otherwise qualify as prior art at the time of filing) are neither expressly nor impliedly admitted as prior art against the present disclosure.

### SUMMARY

The described methods and systems enable direct measurement of shaft torque in control valve assemblies. The measured torque can be utilized to analyze the performance or health of the control valve. The described techniques represent an improvement over typical control valve monitoring and diagnostic techniques. The described techniques utilize a direct measurement of shaft torque, providing a more accurate and precise measurement than an indirect or proxy measurement.

In an embodiment, a system configured to utilize a measurement of shaft torque in a valve is provided. The system may comprise a valve obstructor for a valve. The valve obstructor configured to adjust position relative to the valve body to adjust a flow of material through the valve. The system may comprise a shaft that is mechanically linked to the valve obstructor such that when the shaft moves (e.g., rotates), the obstructor similarly rotates. The system may comprise an actuator that is mechanically linked to the shaft and that is configured to actuate the shaft. The system may comprise a valve controller configured to transmit an actuation signal to the actuator to actuate the shaft and to thereby achieve a desired position or orientation of the valve obstructor. The system may comprise a strain sensor disposed on the shaft and configured to: (i) detect a mechanical deformation of the shaft; (ii) generate, based on the detected mechanical deformation, an electrical signal encoded with the measured value for a torque parameter; and/or (iii) transmit the electrical signal. The system may comprise an electric-to-pressure converter communicatively coupled to both the strain sensor and the valve controller. The electric-to-pressure converter is configured to (i) receive the electrical signal; (ii) decode the electrical signal to detect the measured value; (iii) generate a pressure signal encoded with the measured value; and (iv) transmit, to the valve controller, the pressure signal encoded with the measured value for the torque parameter.

Note, this summary has been provided to introduce a selection of concepts further described below in the detailed description. As explained in the detailed description, certain embodiments may include features and advantages not described in this summary. Further, certain embodiments may omit one or more features or advantages described in this summary

### BRIEF DESCRIPTION OF THE DRAWINGS

FIG. 1A depicts an example valve configured to directly measure and utilize a torque of a shaft of a valve.

FIG. 1B is a block diagram of an example process plant or environment in which the valve shown in FIG. 1A may be implemented to obtain and utilize a direct measurement of shaft torque.

FIG. 2 is a block diagram depicting a diagnostics system (also shown in FIG. 1B) that may be communicatively connected to the valve shown in FIGS. 1A and 1B.

FIG. 3 depicts a perspective view of a valve, which represents an example of the valve shown in FIGS. 1A and 1B.

### DETAILED DESCRIPTION

The described methods and systems enable direct measurement of shaft torque in control valve assemblies. The measured torque can be utilized to analyze the performance or health of the control valve. The described techniques represent an improvement over typical control valve monitoring and diagnostic techniques. The described techniques utilize a direct measurement of shaft torque, providing a more accurate and precise measurement than an indirect or proxy measurement. In an embodiment, a strain gauge is disposed on a shaft between a valve actuator and valve obstructor and is configured to detect a mechanical deformation of the shaft (e.g., twisting, bending, etc.). The strain gauge may generate an electrical signal representing a measured torque corresponding to the detected deformation. This electrical signal may be fed to a converter that is configured to generate a pressure signal corresponding to the received electrical signal. This pressure signal may be fed to the valve controller. The valve controller may receive the pressure signal carrying the measured torque information, and may store the measured torque or implement control in light of the measured torque, if desired. If desired, the valve controller may transmit the measured torque to one or more nodes in the process control system, such as a process controller, a historian, a workstation, etc.

### I. An Example Control Valve with an Example Torque Module

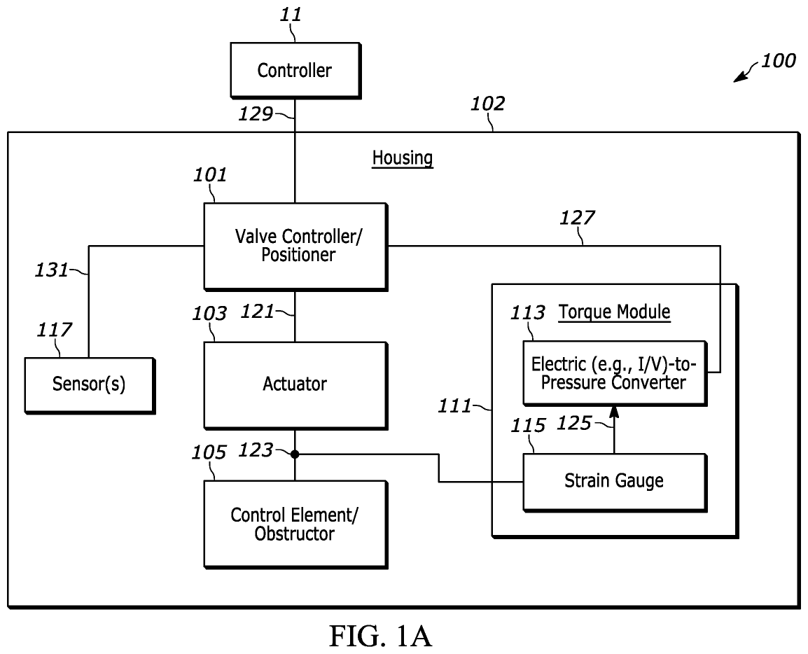

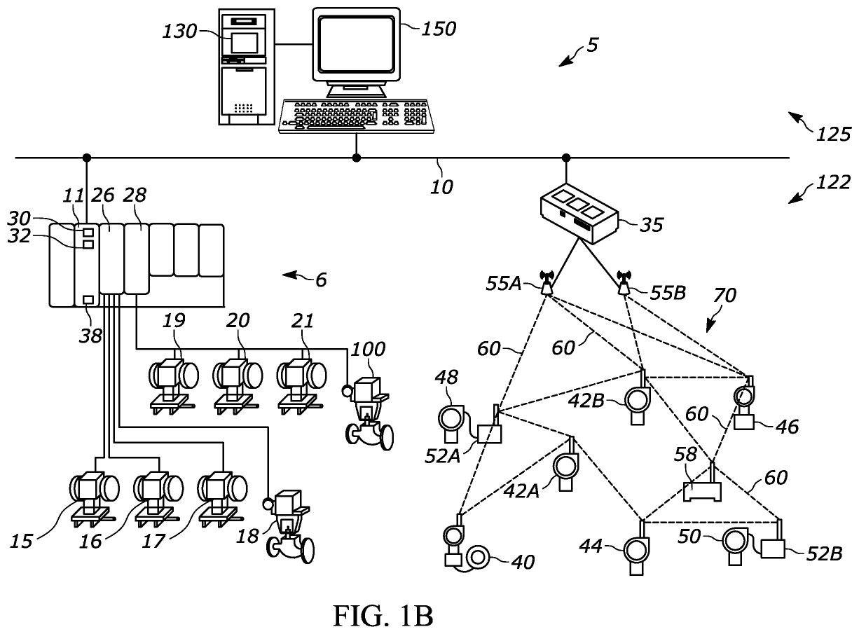

FIG. 1A depicts an example valve 100 configured to directly measure and utilize a torque of a shaft of the valve 100, in accordance with the described techniques. The valve 100 may be any suitable valve 100 configured for a process control environment. For example, it may be a two-way valve, a three-way valve, a four-way valve, etc. In an embodiment, the valve 100 may be communicatively connected to a process controller 11 via a wired or wireless communication link 129, which may connect the valve 100 to a larger I/O network or process control network.

Generally speaking, a “communication link” or a “link” is a telecommunication pathway or medium connecting two or more nodes of a network. When used in the context of system(s) or device(s) that communicate information or data, the term “network” refers to a collection of nodes (e.g., devices or systems capable of sending, receiving or forwarding information) and links, which are connected to enable telecommunication between the nodes. Depending on the embodiment (and unless otherwise stated), each of the described networks may include dedicated routers, switches, or hubs responsible for forwarding directing traffic between nodes, and, optionally, dedicated devices responsible for configuring and managing the network. Some or all of the nodes in the described networks may be also adapted to function as routers in order to direct traffic sent between other network devices. Nodes of the described networks may be inter-connected in a wired or wireless manner, and may have different routing and transfer capabilities.

A link may be a physical link or a logical link. A physical link is the interface or medium(s) over which information is transferred, and may be wired or wireless in nature. Example physicals links include (i) wired links such as cables with a conductor for transmission of electrical energy or a fiber optic connection for transmission of light and (ii) wireless links such as wireless electromagnetic signals that carry information via changes made to one or more properties of electromagnetic waves. Described wireless signals may, for example, oscillate at a frequency within any one or more bands found in the spectrum of roughly 30 kHz to 3,000 GHz (e.g., an 802.11 signal in the 2.4 GHz band). A logical link between two or more nodes represents an abstraction of the underlying physical links or intermediary nodes connecting the two or more nodes. For example, two or more nodes may be logically coupled via a logical link. The logical link may be established via any combination of physical links and intermediary nodes (e.g., routers, switches, or other networking equipment). A link is sometimes referred to as a “communication channel.”

Generally speaking, the term “node” refers to a connection point, redistribution point, or a communication endpoint in a telecommunication network. A node may be any device or system (e.g., a computer system) capable of sending, receiving or forwarding information. For example, end-devices or end-systems that originate or ultimately receive a message are nodes. Intermediary devices that receive and forward the message (e.g., between two end-devices) are also generally considered to be “nodes.”

In any event, the link 129 may be a current signal link (e.g., 4-20 mA), a voltage signal link, a digital link, a wireless link, etc. The link 129 may conform to any suitable process control communication standards or protocols, such as HART®, WirelessHART®, HART-IP®, FOUNDATION® Fieldbus, Profibus, DeviceNet, ControlNet, Modbus, etc. standards. In an embodiment, the link 129 may conform with other protocols or standards, such as any suitable protocol from TCP/IP suite, Bluetooth® protocols, Wi-Fi® protocols, etc. In some embodiments, valve 100 may include multiple links 129, enabling the valve 100 to communicate with other devices via any of a number protocols or standards such as those listed.

The valve 100 may include a valve housing or assembly 102. In some embodiments, the components of the valve 100 may be housed within multiple housings. In any event, the valve 100 may include any one or more of the following (any one of which may be partially or fully disposed within or on the housing 102): a valve positioner or controller 101, an actuator 102, a control element or valve obstructor 105, a torque module 111, and/or one or more sensors 117 (e.g., for measuring valve position, flow rate of material through the valve 100, pressure existing in the valve 100 or in one or more pipes connected to the valve 100, temperature of material in the valve 100 or in the one or more pipes, etc.). The torque module 111 may include a strain gauge 113 or an electric-to-pressure signal converter 115.

The valve controller 101 is a controller or positioner configured to transmit, via the link 129, a signal to the actuator 103 to signal the actuator 103 to actuate, thereby causing the obstructor 105 to move or adjust to a desired position. The desired position may be a position determined via a control routine or module local to the controller 101, or may be a position determined via a command received from the controller 11 via the link 129. The link 121 may be any suitable electric, pneumatic (e.g., air or gas pressure), or hydraulic link for transmitting an actuation signal to the actuator 103. In some instances, the signal transmitted via the link 121 applies a force to move the actuator 103. For example, a pressure signal may exert a force within a diaphragm of the actuator 103, thereby causing a spring within the actuator 103 to compress and thereby exerting a force sufficient to move the obstructor 105 to move (e.g., via a shaft mechanically linking the spring and actuator 103 to the obstructor 105). The valve controller 101 may be a “smart device” including, for example, a processor and memory storing control modules or routines for implementing control of the valve 100 (e.g., based on a command received via the link 129). In some embodiments, the valve controller 101 implements a local control routine that does not rely on measurements or commands from other devices such as the controller 11. In some embodiments, the controller 101 is a “dumb” positioner with no electronic components.

The actuator 103 may be any suitable mechanism for manipulating the obstructor 105 for the purpose of opening or closing the valve 100. The actuator 103 may be a pneumatic, hydraulic, or electric actuator. That is, it may actuate in response to applied air or gas pressure, applied fluid (e.g., oil) pressure, or via force exerted by a motor responsive to an electric signal. The actuator 103 may be mechanically connected to a shaft 123, which it may manipulate to manipulate the obstructor 105. For example, the actuator 103 may rotationally actuate the shaft 123, rotating the shaft around an axis extending centrally through the shaft from one end of the shaft 123 to the other end of the shaft 123, thereby rotating the valve obstructor 105. Said another way, the shaft 123 may actuate by spinning. In an embodiment, the actuator 103 may actuate the shaft 123 in a linear manner, wherein the shaft 123 moves along the axis toward the obstructor 105 or toward the actuator 103.

The valve obstructor 105 may be any control element or obstructor suitable for adjusting an amount of flow through the valve 100. For example, the obstructor may be a rotary obstructor that adjusts flow by rotating. For example, the obstructor 105 may be a ball with a hole drilled through it or a disc. As another example, the obstructor may be linear in nature (e.g., a plug).

The torque module 111 is a set of components configured to detect a torque of the shaft 123 and to transmit to the valve controller 101 a signal carrying the measured torque information. The torque module 111 may include a strain gauge 115 that is disposed on the shaft 123 and oriented depending on the type of torque the shaft 123 is expected to experience (e.g., rotational or linear).

Generally speaking, the strain gauge 115 is a sensor whose resistance varies with applied force. It converts force, pressure, tension, weight, etc., into a change in electrical resistance. In an example, the strain gauge 115 includes an insulating flexible backing which supports a metallic foil pattern. The strain gauge may be attached to the shaft 123 by a suitable adhesive, such as cyanoacrylate. As the shaft 123 deforms (e.g., twists or bends), the foil is deformed, causing its electrical resistance to change. As a general matter, when external forces are applied to a relatively stationary object, stress and strain are the result. Typically, stress is understood as the object's internal resisting forces, and strain is understood as the displacement and deformation that occurs as a result of the forces. Generally speaking, strain may be experienced as tensile or compressive strain (e.g., distinguished by a positive or negative sign). Thus, the strain gauge 115 can be used to pick up expansion of an area of the shaft 123 as well as contraction. The strain gauge 115 may be any one of the following types of strain gauge, depending on the embodiment: a linear strain gauge, a membrane rosette strain gauge, a double linear strain gauge, a full bridge strain gauge, a shear strain gauge, a half bridge strain gauge, a column strain gauge, a 45° Rosette gauge (3 measuring directions), or a 90° Rosette gauge (2 measuring directions). In an embodiment, the strain gauge 115 includes a component that generates a current or voltage signal based on the resistance changes generated in response to torque experienced by the shaft 123, and this signal is transmitted to the converter 113. In an embodiment, the converter 113 directly detects and measures the changes in resistance.

Regardless, the converter 113 is electrically coupled to the strain gauge via the electric or conductive link 125. The converter 113 receives or measures a resistance, current, or voltage signal indicative of torque experienced by the shaft 123. The received or measured value may be any suitable value or range (e.g., 0-10 mV; 0-5V; 1-20V; 4-20 mA; 0-10 k Ohms; 30-3 k Ohms; etc.). The converter 113 decodes the received electrical signal to detect a measured torque value. The converter 113 then generates and transmits a pneumatic signal (e.g., a 3-15 psi signal) via the link 127 to the valve controller 101.

The controller 101 may analyze the received signal to detect the measured torque value. The torque values may be any suitable value or range of values (e.g., 0 ft-lbs-10,000 ft lbs, 400 ft-lbs to 4,600 ft-lbs, etc.). In some instances, the controller 101 may determine whether or not the torque represents a “normal” or expected value. In response to determining that the torque is abnormally high or low (e.g., indicating the shaft has broken or that it is experiencing an unsafe amount of torque), the controller 101 may generate an alarm and/or may take a control action (e.g., driving the obstructor 105 to a safe state).

The valve 100 may include any one or more sensors 117, which may be communicatively coupled to the valve controller 101 via a communication link 117 (e.g., carrying a current signal). The one or more sensors 117 may detect any suitable process output parameter, such as a valve position of the obstructor 105; a temperature, flow rate, or pressure of material flowing through the valve 100; etc. The one or more sensors 117 may transmit the detected or sensed parameter to the valve controller 101, which may implement control in a manner that accounts for the detected parameter. If desired, the controller 101 may transmit the detected parameter to one or more other devices in a plant network or I/O network (e.g., a process controller, an I/O device, a workstation, etc.). In some embodiments, any one or more of the sensors 117 may transmit the detected parameter directly to such devices (e.g., to a process controller).

### II. An Example Plant Environment

FIG. 1B is a block diagram of an example process plant or environment 5 in which the valve assembly 100 (also shown in FIG. 1A) may be implemented to obtain and utilize a direct measurement of shaft torque. The process plant 5 controls a process that may be said to have one or more “process outputs” characterizing the state of the process (e.g., tank levels, flow rates, material temperatures, etc.) and one or more “process inputs” (e.g., the state of various environmental conditions and actuators, the manipulation of which may cause process outputs to change). The process plant or control system 5 of FIG. 1B includes a field environment 122 (e.g., “the process plant floor 122”) and a back-end environment 125, each of which is communicatively connected by a process control backbone or data highway 10. The backbone 10 (sometimes referred to as the “link 10” or “network 10”) may include one or more wired or wireless communication links, and may be implemented using any desired or suitable communication protocol, such as an Ethernet protocol.

Generally speaking, as used herein and unless otherwise specified, the term “network” refers to a collection of nodes (e.g., devices or systems capable of sending, receiving or forwarding information) and links which are connected to enable telecommunication between the nodes. Depending on the embodiment (and unless otherwise stated), each of the described networks may include dedicated routers, switches, or hubs responsible for forwarding directing traffic between nodes, and, optionally, dedicated devices responsible for configuring and managing the network. Some or all of the nodes in the described networks may be also adapted to function as routers in order to direct traffic sent between other network devices. Nodes of the described networks may be inter-connected in a wired or wireless manner, and may have different routing and transfer capabilities. Nodes disposed in the field environment 122 may be configured to withstand expected or potential conditions in the field environment 122. For example, one or more nodes may be intrinsically safe, enabling deployment in hazardous environments. Similarly, nodes in the networks of the plant 5 may be specially configured to meet communication demands unique to process control environments (e.g., may be configured to have increased reliability and/or redundancy).

At a high level (and as shown in FIG. 1B), the field environment 122 includes physical components (e.g., process control devices, networks, network elements, etc.) that are disposed, installed, and interconnected to operate to control the process during run-time. For example, the field environment 122 includes an I/O network 6. By and large, the components of the I/O network 6 are located, disposed, or otherwise included in the field environment 122 of the process plant 5. Generally speaking, in the field environment 122 of the process plant 5, raw materials are received and processed using the physical components disposed therein to generate one or more products.

By contrast, the back-end environment 125 of the process plant 5 includes various components such as computing devices, operator workstations, databases or databanks, etc. that are shielded or protected from the harsh conditions and materials of the field environment 122. In some configurations, various computing devices, databases, and other components and equipment included in the back-end environment 125 of the process plant 5 may be physically located at different physical locations, some of which may be local to the process plant 5, and some of which may be remote. If desired, any component in the back-end environment 125 may receive data generated or transmitted by the control valve 100.

As noted, the field environment 122 includes one or more I/O networks such as the I/O network 6, each of which includes: (i) one or more controllers, (ii) one or more field devices communicatively connected to the one or more controllers, and (iii) one or more intermediary nodes (e.g., UO cards or modules) facilitating communication between the controllers and the field devices. As shown, the I/O network 6 may include the control valve 100, which may be communicatively linked to the process controller 11 via an I/O card 26 or 28. In some embodiments, field devices may communicate directly with the controllers (e.g., without the I/O cards).

Generally, at least one field device performs a physical function (e.g., opening or closing a valve, increasing or decreasing a temperature, taking a measurement, sensing a condition, etc.) to control the operation of a process implemented in the process plant 5. The field devices may be thought of as a means to manipulate a process input (e.g., a valve position or pump status) or to measure a process output (e.g., a tank level, a flow speed, a pressure, a temperature, a temperature, etc.). For example, the control valve 100 is configured to open or close, thereby controlling a flow through a pipe to which the valve 100 is connected. The valve 100 may adjust its valve position (e.g., 0% open, 50% open, 100% open) in response to commands received from the controller 11. If desired, the control valve 100 may include one or more sensors for detecting valve position, flow rate of material through the valve, temperature of material through the valve, pressure present in the pipe or valve. The control valve 100 may transmit these detected or measured parameters to the controller 11. If desired, the controller 11 may provide the measurements to any one or more nodes in the I/O network 6 or in the plant network 5. In some embodiments, the control valve 100 may be capable of transmitting (e.g., via wired or wireless transmission) measurements directly to these other nodes rather than routing the measurements through the controller 11.

As noted, some types of field devices communicate with controllers via I/O devices (sometimes called “I/O cards”). The process controllers, field devices, and I/O cards described herein may be configured for wired or wireless communication. Any number and combination of wired and wireless process controllers, field devices, and I/O devices may be included in the process plant environment or system 5. For example, the field environment 122 includes the I/O network 6, which includes a process controller 11 communicatively connected, via an I/O card 26 and an I/O card 28, to a set of wired field devices 15-22. If desired, the control valve 100 may be communicatively linked to the process controller 11 via an I/O card such as the I/O card 26 or 28.

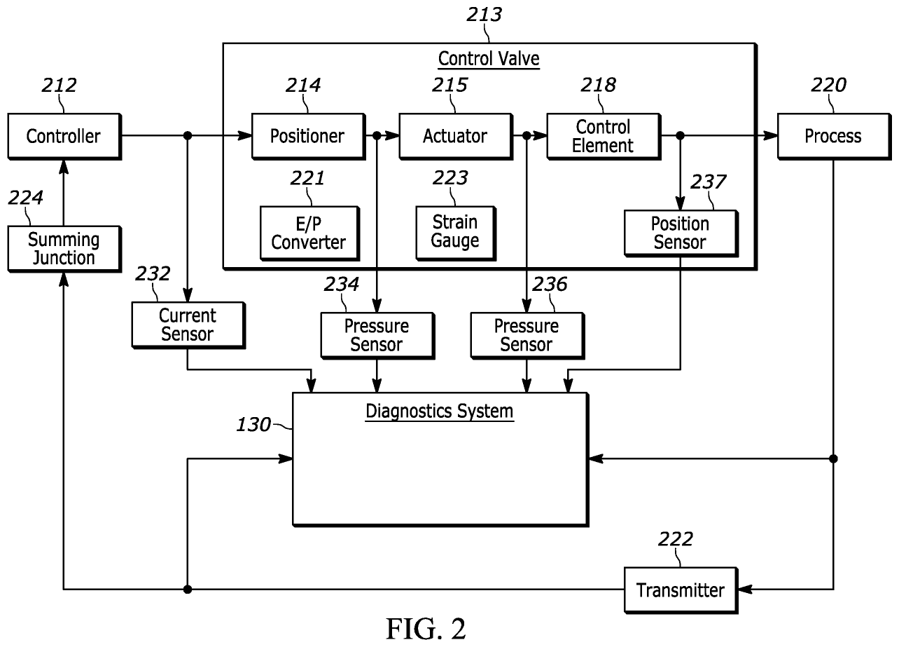

The field environment 122 also includes a wireless network 70 including a set of wireless field devices 40-46 coupled to the controller 11 (e.g., via a wireless gateway 35 and the network 10). The wireless network 70 may be a part of the I/O network 6, or may be a part of an I/O network not shown in FIG. 1B (and may include controllers or I/O cards not shown in FIG. 2). In some implementations, the valve controller 101 of the valve 100 may include circuitry capable of wirelessly receiving or transmitting any of the data described herein as being transmitted or received by the control valve 100. This data may be transmitted or received via any suitable wireless protocol (e.g., WirelessHart, Bluetooth, WiFi, etc.). If desired, the valve controller 101 may be configured to communicate via a wired link. In such instances, the valve controller 101 may be communicatively linked to an external wireless transceiver or adapter that gives the valve 100 wireless capability.

In some configurations, the controller 11 may be communicatively connected to the wireless gateway 35 using one or more communications networks other than the backbone 10, such as by using any number of other wired or wireless communication links that support one or more communication protocols, e.g., Wi-Fi or other IEEE 802.11 compliant wireless local area network protocol, mobile communication protocol (e.g., WiMAX, LTE, or other ITU-R compatible protocol), Bluetooth®, HART®, WirelessHART®, Profibus, FOUNDATION® Fieldbus, etc.

The controller 11, which may be the DeltaV™ controller sold by Emerson Process Management, may operate to implement a batch process or a continuous process using at least some of the field devices 15-22 and 40-46. In addition to being communicatively connected to the process control data highway 10, the controller 11 is also communicatively connected to at least some of the field devices 15-22 and 40-46 using any desired hardware and software associated with, for example, standard 4-20 mA devices, I/O cards 26, 28, or any smart communication protocol such as the FOUNDATION® Fieldbus protocol, the HART® protocol, the WirelessHART® protocol, etc. In FIG. 1B, the controller 11, the field devices 15-22 and the I/O cards 26, 28 are wired devices; and the field devices 40-46 are wireless field devices. Of course, the wired field devices 15-22 and wireless field devices 40-46 could conform to any other desired standard(s) or protocols, such as any wired or wireless protocols, including any standards or protocols developed in the future.

The process controller 11 includes a processor 30 that implements or oversees one or more process control routines 38 (e.g., that are stored in a memory 32). The processor 30 is configured to communicate with the field devices 15-22 and 40-46 and with other nodes communicatively connected to the controller 11. Note, any control routines or modules described herein may have parts thereof implemented or executed by different controllers or other devices if so desired. Likewise, the control routines or modules 38 described herein which are to be implemented within the process control system 5 may take any form, including software, firmware, hardware, etc. Control routines may be implemented in any desired software format, such as using object-oriented programming, ladder logic, sequential function charts, function block diagrams, or using any other software programming language or design paradigm. The control routines 38 may be stored in any desired type of memory 32, such as random-access memory (RAM), or read only memory (ROM). Likewise, the control routines 38 may be hard-coded into, for example, one or more EPROMs, EEPROMs, application specific integrated circuits (ASICs), or any other hardware or firmware elements. Put simply, the controller 11 may be configured to implement a control strategy or control routine in any desired manner.

The controller 11 implements a control strategy using what are commonly referred to as function blocks, where each function block is an object or other part (e.g., a subroutine) of an overall control routine. The controller 11 may operate in conjunction with function blocks implemented by other devices (e.g., other controllers or field devices) to implement process control loops within the process control system 5.

Generally speaking, the phrase “control loop” refers to a particular set of process control devices and/or software modules (e.g., function blocks) used to achieve a particular control objective (e.g., controlling an inlet valve to a tank based on one or more measured process parameters). Furthermore, each valve or other device may (such as the valve 100), in turn, include an inner loop wherein, for example, a valve positioner or valve controller controls a valve actuator (which may be electric, pneumatic, or hydraulic in nature) to move a valve obstructor or final control element, such as a valve plug. The valve positioner or controller may move the valve obstructor in response to a control signal (e.g., from a controller such as the controller 11), and may obtain feedback from a sensor (such as a position sensor) to control movement of the control element or obstructor (thereby controlling an amount of flow through the valve).

In the case of a pneumatic valve actuator, the control element or valve obstructor may move in response to changing air or gas pressure on an actuator such as a spring biased diaphragm, which may be caused by a valve positioner or controller responding to a change in the command signal (in other instances, the valve controller may execute an internal or local control routine that causes it to move the control element). For example, in one standard valve mechanism, a command signal with a magnitude varying in the range of 4 to 20 mA (milliamperes) causes the valve positioner or controller to alter the amount of air and thus, the air pressure, within a pressure chamber in proportion to the magnitude of the command signal (e.g., by transmitting a corresponding 3-15 psi signal) to the pressure chamber. Changing air pressure in the pressure chamber causes the actuator (i.e., the spring-based diaphragm in this example) to move, which causes the control element (e.g., a valve plug, a rotating disc or ball, etc.) to move. Typically, accurate and precise control depends on a known relationship between (i) a change in pressure exerted on the control element and (ii) the resulting travel of the control element (sometimes simply referred to as travel of the valve).

Returning to function blocks, function blocks typically perform one of: (i) an input function, such as that associated with a transmitter, a sensor or other process parameter measurement device (sometimes referred to as “input blocks”); (ii) a control function, such as that associated with a control routine that performs PID, fuzzy logic, etc. (sometimes referred to as “control blocks”); or (iii) an output function which controls the operation of some device, such as a valve, to perform some physical function within the process control system 5 (sometimes referred to as “output blocks”). Of course, hybrid and other types of function blocks exist.

Function blocks may be stored in and executed by the controller 11, which is typically the case when these function blocks are used for, or are associated with standard 4-20 mA devices and some types of smart field devices such as HART® devices, or may be stored in and implemented by the field devices themselves, which can be the case with FOUNDATION® Fieldbus devices. For example, in some instances the valve controller 101 of the valve 100 may be a “smart” field device that stores and executes function blocks (e.g., representing an inner or internal control loop for the valve 100). One or more of the control routines 38 may implement one or more control loops which are performed by executing one or more of the function blocks.

If desired, the controller 11 may be configured to control one or more valves and/or one or more pumps based on data received from the control valve 100. For example, the controller 11 may reposition the valve 100 and/or one or more upstream or downstream valves or pumps when a detected flow at the valve 100 is considered too high or too low. Further, the controller 11 may be configured to control the valve 100 based on data from other field devices. For example, in an embodiment, the valve 100 may be an inlet valve to a tank that the controller 11. In such an embodiment, the controller 11 may transmit a command to the valve 100 to cause the valve 100 to close or restrict flow in response to the controller 11 detecting a tank level reaching or approaching a threshold (e.g., based on data from a level sensor disposed at the tank). Likewise, in such an embodiment in which the valve 100 is an inlet valve to a tank, the controller 11 may transmit a command to the valve 100 to cause the valve 100 to open and thereby increase inflow to the tank when a low tank level is detected.

In any event, the wired field devices 15-22 may be any types of devices, such as sensors, valves, transmitters, positioners, etc., while the I/O cards 26 and 28 may be any types of process control I/O devices conforming to any desired communication or controller protocol. In FIG. 1B, the field devices 15-18 are standard 4-20 mA devices or HART® devices that communicate over analog lines or combined analog and digital lines to the I/O card 26, while the field devices 19-22 are smart devices, such as FOUNDATION® Fieldbus field devices, that communicate over a digital bus to the I/O card 28 using a FOUNDATION® Fieldbus communications protocol. Additionally or alternatively, in some embodiments at least some of the wired field devices 15-22 or at least some of the I/O cards 26, 28 communicate with the controller 11 using the process control data highway 10 or by using other suitable control system protocols (e.g., Profibus, DeviceNet, Foundation Fieldbus, ControlNet, Modbus, HART, etc.).

In FIG. 1B, the wireless field devices 40-46 communicate via a wireless process control communication network 70 using a wireless protocol, such as the WirelessHART® protocol. Such wireless field devices 40-46 may directly communicate with one or more other devices or nodes of the wireless network 70 that are also configured to communicate wirelessly (using the wireless protocol or another wireless protocol, for example). To communicate with one or more other nodes that are not configured to communicate wirelessly, the wireless field devices 40-46 may utilize a wireless gateway 35 connected to the process control data highway 10 or to another process control communications network. The wireless gateway 35 provides access to various wireless devices 40-58 of the wireless communications network 70. In particular, the wireless gateway 35 provides communicative coupling between the wireless devices 40-58, the wired devices 11-28, or other nodes or devices of the process control plant 5. For example, the wireless gateway 35 may provide communicative coupling by using the process control data highway 10 or by using one or more other communications networks of the process plant 5.

Similar to the wired field devices 15-22, the wireless field devices 40-46 of the wireless network 70 perform physical control functions within the process plant 5, e.g., opening or closing valves, or taking measurements of process parameters. The wireless field devices 40-46, however, are configured to communicate using the wireless protocol of the network 70. As such, the wireless field devices 40-46, the wireless gateway 35, and other wireless nodes 52-58 of the wireless network 70 are producers and consumers of wireless communication packets.

In some configurations of the process plant 5, the wireless network 70 includes non-wireless devices. For example, in FIG. 1B, a field device 48 is a legacy 4-20 mA device and a field device 50 is a wired HART® device. To communicate within the network 70, the field devices 48 and 50 are connected to the wireless communications network 70 via a wireless adaptor 52a, 52b. The wireless adaptors 52a, 52b support a wireless protocol, such as WirelessHART, and may also support one or more other communication protocols such as Foundation® Fieldbus, PROFIBUS, DeviceNet, etc. If desired, the valve 100 may be coupled to the wireless network 70 (and, e.g., a controller) via an adapter such as the adapters 52a/b.

Additionally, in some configurations, the wireless network 70 includes one or more network access points 55a, 55b, which may be separate physical devices in wired communication with the wireless gateway 35 or may be provided with the wireless gateway 35 as an integral device. The wireless network 70 may also include one or more routers 58 to forward packets from one wireless device to another wireless device within the wireless communications network 70. In FIG. 1B, the wireless devices 40-46 and 52-58 communicate with each other and with the wireless gateway 35 over wireless links 60 of the wireless communications network 70, or via the process control data highway 10.

As noted, the back-end environment 125 may include various components such as computing devices, operator workstations, databases or databanks, etc. that are typically shielded or protected from the harsh conditions and materials of the field environment 122. The back-end environment 125 may include any one or more of the following, each of which may be communicatively connected to the data highway 10: (i) one or more operator workstation(s) (e.g., configured to display, to an operator, data from the valve 100; or configured to enable the operator to transmit a command to the valve 100); (ii) a configuration application and a configuration database (e.g., to enable configuration of the valve 100); (iii) a data historian application and a data historian database (e.g., to store historical information from the valve 100, such as measured valve positions, measured flows, or diagnostic information generated by the valve 100); (iv) one or more other wireless access points that communicate with other devices using other wireless protocols; and (v) one or more gateways to systems external to the immediate process control system 5. FIG. 1B depicts a host 150 (which may be any suitable computer or server). Any one or more of the described components of the back-end environment 125 may be implemented on a computer or host such as the host 150.

As shown, the plant 5 may include a diagnostics system 130, which may execute on a host (sometimes referred to as a “server,” “computer,” etc.) 150 and may be communicatively coupled to the data highway 10. The host 150 may be any suitable computing device, and may include a memory (not shown) storing the system 130 as one or more modules, applications, or sets of instructions; and a processor (not shown) to execute the system 130. The memory may be any system or device including non-transitory computer readable media for placing, keeping, and/or receiving information (e.g., RAM, ROM, EEPROM, flash memory, optical disc storage, magnetic storage, etc.). In some configurations, the host 150 may be a portable handheld tool, including a touch interface, for example. Further, in some instances, the system 130 is an application-specific integrated circuit (ASIC). While FIG. 1B shows the host 150 as including a display, in some instances the host 150 does not include a display. In any event, the diagnostics system 130 may perform diagnostic analysis on data received from the valve 100 (e.g., diagnostic analysis of measured torque values from a shaft of the valve 100).

### III. An Example Control Loop

FIG. 2 is a block diagram depicting the diagnostics system 130 (also shown in FIG. 1B) communicatively connected to a control valve 213 (e.g., an example embodiment of the valve 100 shown in FIGS. 1A and 1B), which is part of a single-input, single-output process control loop 210. As shown, the control valve 213 may include a positioner or valve controller 214, an actuator 215, a control element or obstructor 218, a sensor 237, a strain gauge 223, and an electric-to-pressure converter 221. These components represent examples of the valve controller 101, the actuator 103, the obstructor 105, the sensor(s) 117, the strain gauge 115, and the converter 113 shown in FIG. 1A, respectively, and may have the same or similar configuration and/or functionality as the respective components shown in FIG. 1A.

In example operation, the diagnostics system 130 collects information from the control valve 213 and various sensors, and uses this information to perform online diagnostics, offline diagnostics, and/or an integrated analysis of diagnostics data resulting from the online and offline diagnostics, enabling the diagnostics system 130 to track the behavior and health of the control valve 213. Specifically, the system 130 may track torque and the relationship between torque and other variables at a given time (e.g., e.g., relationships between torque and valve travel, actuator pressure, flow through the valve, etc.). The system 130 may track maximum torque observed, minimum torque observed, average torque observed, etc. After enough information has been collected, the system 130 may generate torque signatures (e.g., “normal” ranges for torque for a given valve position and/or for a given actuator pressure). The components of the control loop 210 are described below, followed by a discussion of the system 130 and its interactions with the components of the control loop 210.

In addition to the control valve 213, the control loop 210 includes a transmitter 222, summing junction 224, and a controller 212 (e.g., representing an example of the controller 11 shown in FIGS. 1A and 1B). In example operation, the process controller 212 controls the control valve 213 to manipulate a process variable of a process 220. To implement control of the valve 213, the controller 212 sends, for example, a 4 to 20 mA command signal to the control valve 213.

A transmitter 222 may measure a process variable of the process 220 and may transmit an indication of the measured process variable to the summing junction 224. The summing junction 224 compares the measured value of the process variable (converted into a normalized percentage) to a set point to produce an error signal indicative of the difference. The summing junction 224 then provides the calculated error signal to the process controller 212. The set point, which may be generated by a user, an operator or another controller is typically normalized to be between 0 and 100 percent and indicates the desired value of the process variable. The process controller 212 uses the error signal to generate the command signal according to any desired technique and delivers the command signal to the control valve 213 to thereby effect control of the process variable.

As noted, the diagnostics system 130 collects data from various devices in the loop 210 and utilizes the collected data to estimate various loop parameters (torque, valve travel, actuator pressure, friction, dead time, dead band, etc.) and to perform online and offline diagnostics. One or more components of the system 130 may be implemented by a host such as the host 150 shown in FIG. 1B. In some configurations, one or more components of the diagnostics system 130 can be internal to the control valve 213 or any other process control device (e.g., field device) in a process control network. For example, the system 130 may be distributed and implemented via multiple devices. If the control valve 213 is a microprocessor-based device, the diagnostics system 130 can share the same processor and memory as that already within the control valve 213. Thus, it is contemplated that a statistical analysis (e.g., of torque information) may be performed in the device in which the measurements (e.g., of shaft torque) are made with the results being sent to a user display or to a host device (e.g., the host 150) for use. Alternatively, the signal measurements may be made by a device (such as the valve 213) with such measurements then being sent to a remote location (such as the host 150) where the statistical analysis is performed. In any event, regardless of the precise nature of the system 130, the system 130 may collect data pertaining to the valve 213 (e.g., via sensors internal and/or external to the valve 213).

For example, the diagnostics system 130 may detect one or more of the command signals delivered to the positioner 214 using a current sensor 232, the pressure output from the positioner 214 using a pressure sensor 234, the actuator command signal output by the actuator 215 using a pressure sensor 236, and the valve position at the output of the control element 218 using a position sensor 237. If desired, the diagnostics system 130 may also or alternatively detect the set point signal, the error signal at the output of the summing junction 224, the process variable, the output of the transmitter 222 or any other signal or phenomena that causes or indicates movement or operation of the control valve 213 or process control loop 210. It should also be noted that other types of process control devices may have other signals or phenomena associated therewith that may be used by the diagnostics system 130. Depending on the embodiment, the pressure sensors 234 and/or 236 may be housed within an assembly or housing of the control valve 213 (e.g., within a housing of the positioner 214), or may be disposed somewhere external to the control valve 213.

As will be evident, the diagnostics system 130 may also read an indication of the controller command signal, the pressure signal, the actuator command signal, or the valve position when the control valve 213 is configured to communicate those measurements. Likewise, the diagnostics system 130 may detect signals generated by other sensors already within the control valve 213, such as the valve position indicated by the position sensor 237. Of course, the sensors used by the diagnostics system 130 can be any known sensors and may be either analog or digital sensors. For example, the position sensor 237 may be any desired motion or position measuring device including, for example, a potentiometer, a linear variable differential transformer (LVDT), a rotary variable differential transformer (RVDT), a Hall effect motion sensor, a magneto resistive motion sensor, a variable capacitor motion sensor, etc. It will be understood that, if the sensors are analog sensors, the diagnostics system 130 may include one or more analog-to-digital converters which samples the analog signal and stores the sampled signal in a memory within the diagnostics system 130. However, if the sensors are digital sensors, they may supply digital signals directly to the diagnostics system 130 which may then store those signals in memory in any desired manner. Moreover, if two or more signals are being collected, the diagnostics system 130 may store these signals as components of data points associated with any particular time. For example, each data point at time T1, T2, . . . Tn may have an input command signal component, a pressure signal component, an actuator travel signal component, a measured torque component, a flow rate component, etc. Of course, these data points or components thereof may be stored in memory in any desired or known manner.

### IV. An Example Control Valve

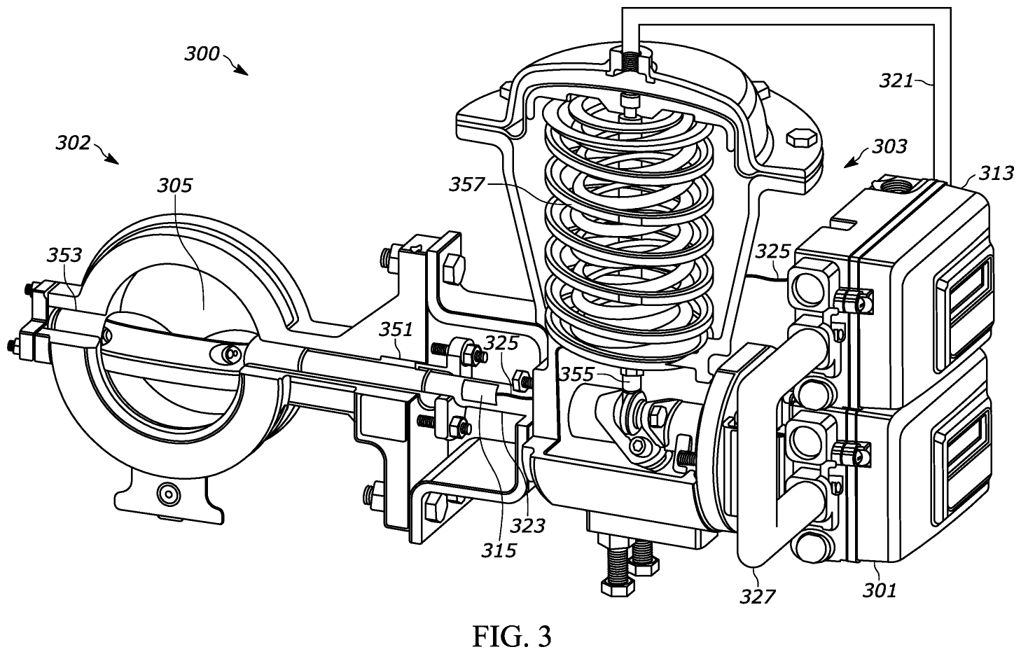

FIG. 3 depicts a perspective view of a valve 300, which represents an example of the valve 100 shown in FIGS. 1A and 1B. As shown, the control valve 300 may include a positioner or valve controller 301, an actuator 303, a control element or obstructor 305, an electric-to-pressure converter 313, a strain gauge 315, an actuation link 321 (e.g., carrying a pressure signal from the controller 301 to the actuator 303), a shaft 323, an electric or conductive link 325, and a link 327 (e.g., carrying a pressure or pneumatic signal). These components represent examples of the valve controller 101, the actuator 103, the obstructor 105, the sensor(s) 117, the electric-to-pressure converter 113, the strain gauge 115, the actuation link 121, the shaft 123, the electric or conductive link 125, and the link 127 shown in FIG. 1A, respectively, and may have the same or similar configuration and/or functionality as the respective components shown in FIG. 1A.

As shown, the valve 300 includes packing 351, which acts as a seal that allows motion of the stem or shaft 323 while sealing process fluid so no leaks occur between the moving stem 323 and the actuator 303. In order to form the seal, the packing 351 may exert force against the shaft 323. Unfortunately, this may also result in an applied resistance, causing the portion of the shaft 323 in contact with the packing 351 to resist rotation driven by the actuator 303. The strain gauge 315 can be utilized to detect mechanical deformation and torque resulting from this resistance, enabling the controller 301 to take corrective action if the torque becomes excessive and unsafe. Like the strain gauge 115, the strain gauge 315 may be attached to the shaft in any suitable manner, such as by using an adhesive.

The strain gauge 315 may be electrically coupled to the electric-to-pressure converter 313 via the link 325. As with the converter 113, the converter 313 may detect an electrical characteristic from the strain gauge 315 representing a degree of mechanical deformation (e.g., resistance, current, voltage, etc.). In some embodiments, the housing of the valve controller 301 may house the electric-to-pressure converter 313. In the depicted embodiment, the link 325 extends away from strain gauge 315 down the shaft 325 toward the body of the actuator 303, wraps around the back end of the actuator 303, and connects to the converter 313. In some embodiments, the link 325 may extend through the body of the actuator 303 to connect to the converter 313. The link 325 may travel between the strain gauge 315 and the converter 313 in suitable manner, and may be insulated in any suitable wire insulation.

A cavity 353 of the housing 302 may be configured to receive an end of a shaft connected to the obstructor, enabling the obstructor 305 to properly sit within the assembly 302 and to rotate.

As shown, the actuator 303 includes a spring 357 and an actuator shaft 355 that is mechanically linked to the shaft 323. As air pressure increases at the top of the actuator 303, the spring 357 is compressed and the actuator shaft 355 strokes to drive the shaft 323. In the shown example, the linkage between the shaft 355 and the shaft 323 operates to transfer linear motion to rotational motion. That is, an up and down motion of the shaft 355 is transferred to a spinning motion of the shaft 323. In some embodiments, a strain gauge may be placed on the actuator shaft 355 in addition to or instead of on the shaft 323.

In example operation, the strain gauge 315 detects a mechanical deformation of the shaft 323. The strain gauge 315 may generate, based on the detected mechanical deformation, an electrical signal corresponding to the detected mechanical deformation (e.g., which corresponds to a given torque exerted on the shaft 323). For example, the strain gauge 315 may be configured to change in resistance as the strain gauge itself deforms along with the shaft 323 deforming. In an embodiment, the strain gauge 315 may include or otherwise communicate with a component that generates a current or voltage signal corresponding to the detected deformation.

In any event, the electric-to-pressure converter 313 receives the electrical signal (representing the detected deformation or measured torque value (e.g., via the link 325). The electric-to-pressure converter 313 detects the electrical signal and decodes the electrical signal to determine the measured value corresponding to the signal (e.g., corresponding to the resistance value, the current value, the voltage value, etc.). For example, the converter 313 may determine a measured torque value corresponding to a detected resistance, current, or voltage. The electric-to-pressure converter 313 may then encode a pressure signal (e.g., a 3-15 psi signal) that is transmitted via the link 327 from the electric-to-pressure converter 313 to the valve controller 301.

When the valve controller 301 receives the signal, the controller 301 may decode the signal to detect the measured torque. The controller 301 may analyze the torque value to determine if it falls outside a safe range. In some instances, the controller 301 identifies safe or unsafe ranges of torque based on an analysis of historical torque vales. In some instances, the controller 301 analyzes a relationship between torque and another parameter, such as valve travel, actuator pressure, flow rate through the valve, etc., and may compare this relationship to an expected relationship or expected range of relationships (e.g., determined from an analysis of historical data). In some instances, the controller 301 transmits the torque to one or more other nodes in the process plant 5 (e.g., the process controller 11). The controller 11 may then analyze the torque value and may take control action in response to determining, for example, that the value is in an unsafe range (e.g., by transmit a command to the controller 301 to drive the valve to a safe state). In some instances, one or more devices in the process plant 5 (e.g., the valve controller 301, the controller 11, the host 150, etc.) may generate an alarm when the torque value represents an unexpected or unsafe value.

In some embodiments, the valve 300 may have a different configuration. For example, in some instances, the link 327 between the controller 301 and the converter 313 may be positioned on the other side of the controller 301 and the converter 313. In some instances, one side of the converter 313 and 301 may include electrical connections and a second side may have pneumatic connections such as the pneumatic link 327. In some instances, the controller 301 may provide power to the converter 313. In an embodiment, the controller 301 includes an on-board pressure sensor it utilizes to detect the signal carried via the link 327. In some embodiments, the controller 301 utilizes a pressure sensor disposed external to the housing of the controller 301 for reading the signal carried via the link 327. In either situation, one or more processors of the controller 301 may receive the signal value (carried by the link 327) from such a pressure sensor via any suitable means of communication (e.g., the pressure sensor may transmit the value, detected from the pressure link 327, to the processor(s) of the controller 301 via an electric signal).

### V. Additional Considerations

When implemented in software, any of the applications, services, and engines described herein may be stored in any tangible, non-transitory computer readable memory such as on a magnetic disk, a laser disk, solid state memory device, molecular memory storage device, or other storage medium, in a RAM or ROM of a computer or processor, etc. Although the example systems disclosed herein are disclosed as including, among other components, software or firmware executed on hardware, it should be noted that such systems are merely illustrative and should not be considered as limiting. For example, it is contemplated that any or all of these hardware, software, and firmware components could be embodied exclusively in hardware, exclusively in software, or in any combination of hardware and software. Accordingly, while the example systems described herein are described as being implemented in software executed on a processor of one or more computer devices, persons of ordinary skill in the art will readily appreciate that the examples provided are not the only way to implement such systems.

Referencing the method 400 specifically, the described functions may be implemented, in whole or in part, by the devices, circuits, or routines of the system 5 shown in FIG. 1B. The method 400 may be embodied by a set of circuits that are permanently or semi-permanently configured (e.g., an ASIC or FPGA) to perform logical functions of the respective method or that are at least temporarily configured (e.g., one or more processors and a set instructions or routines, representing the logical functions, saved to a memory) to perform the logical functions of the respective method.

Throughout this specification, plural instances may implement components, operations, or structures described as a single instance. Although individual operations of one or more methods are illustrated and described as separate operations, one or more of the individual operations may be performed concurrently in certain embodiments.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Further, the phrase “wherein the system includes at least one of X, Y, or Z” means the system includes an X, a Y, a Z, or some combination thereof. Similarly, the phrase “wherein the component is configured for X, Y, or Z” means that the component is configured for X, configured for Y, configured for Z, or configured for some combination of X, Y, and Z.

In addition, use of the “a” or “an” are employed to describe elements and components of the embodiments herein. This description, and the claims that follow, should be read to include one or at least one. The singular also includes the plural unless it is obvious that it is meant otherwise.

Generally speaking, as used herein the phrase “memory” or “memory device” refers to a system or device including computer-readable media or medium (“CRM”). “CRM” refers to a medium or media accessible by the relevant computing system for placing, keeping, or retrieving information (e.g., data, computer-readable instructions, program modules, applications, routines, etc.). Note, “CRM” refers to media that is non-transitory in nature, and does not refer to disembodied transitory signals, such as radio waves.

The CRM may be implemented in any technology, device, or group of devices included in the relevant computing system or in communication with the relevant computing system. The CRM may include volatile or nonvolatile media, and removable or non-removable media. The CRM may include, but is not limited to, RAM, ROM, EEPROM, flash memory, or other memory technology, CD-ROM, digital versatile disks (DVD) or other optical disk storage, magnetic cassettes, magnetic tape, magnetic disk storage or other magnetic storage devices, or any other medium which can be used to store information and which can be accessed by the computing system. The CRM may be communicatively coupled to a system bus, enabling communication between the CRM and other systems or components coupled to the system bus. In some implementations the CRM may be coupled to the system bus via a memory interface (e.g., a memory controller). A memory interface is circuitry that manages the flow of data between the CRM and the system bus.

The various operations of example methods described herein may be performed, at least partially, by one or more described or implicitly disclosed controllers or processors (e.g., processors of the valves 100/212/300; a processor the host 150; etc.). Generally speaking, the terms “processor” and “microprocessor” are used interchangeably, each referring to a computer processor configured to fetch and execute instructions stored to memory.

By executing these instructions, the disclosed processor(s) can carry out various operations or functions defined by the instructions. The disclosed processor(s) may be temporarily configured (e.g., by instructions or software) or permanently configured to perform the relevant operations or functions (e.g., a processor for an Application Specific Integrated Circuit, or ASIC), depending on the particular embodiment. Each disclosed processor may be part of a chipset, which may also include, for example, a memory controller or an I/O controller. A chipset is a collection of electronic components in an integrated circuit that is typically configured to provide I/O and memory management functions as well as a plurality of general purpose or special purpose registers, timers, etc. Generally speaking, one or more of the described processors may be communicatively coupled to other components (such as memory devices and I/O devices) via a system bus.

The performance of certain of the operations may be distributed among the one or more processors, not only residing within a single machine, but deployed across a number of machines. For example, when a single processor is described as performing a set of operations, it is understood that multiple processors may perform the set of operations in some embodiments according to any desired distribution across the multiple processors. In some example embodiments, the processor or processors may be located in a single location (e.g., within a home environment, an office environment or as a server farm), while in other embodiments the processors may be distributed across a number of locations.

Words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Unless otherwise noted, a “routine,” “module,” or “application” described in this disclosure refers to a set of computer-readable instructions that may be stored on a CRM. Generally, a CRM stores computer-readable code (“code”) representing or corresponding to the instructions, and the code is adapted to be executed by a processor to facilitate the functions described as being represented by or associated with the routine or application. Each routine or application may be implemented via a stand-alone executable file, a suite or bundle of executable files, one or more non-executable files utilized by an executable file or program, or some combination thereof. In some instances, unless otherwise stated, one or more of the described routines may be hard-coded into one or more EPROMs, EEPROMs, application specific integrated circuits (ASICs), field programmable gate arrays (FPGAs), or any other hardware or firmware elements.

Further, unless otherwise stated, each routine or application may be embodied as: (i) a stand-alone software program, (ii) a module or sub-module of a software program, (iii) a routine or sub-routine of a software program, or (iv) a resource invoked or accessed by a software program via a “call” to thereby cause the system to implement the task or function associated with the resource. Each routine may be represented by code implemented in any desired language, such as source code (e.g., interpretable for execution or compilable into a lower level code), object code, bytecode, machine code, microcode, or the like. The code may be written in any suitable programming or scripting language (e.g., C, C++, Java, Actionscript, Objective-C, Javascript, CSS, Python, XML, Swift, Ruby, Elixir, Rust, Scala, or others).

Finally, the patent claims at the end of this document are not intended to be construed under 35 U.S.C. § 112(f) unless traditional means-plus-function language is expressly recited, such as “means for” or “step for” language being explicitly recited in the claim(s). At least some aspects of the systems and methods described herein are directed to an improvement to computer functionality, and improve the functioning of conventional computers.

What is claimed is:

1. A system configured to utilize a measurement of shaft torque in a valve, the system comprising:
a valve obstructor for a valve, the valve obstructor configured to adjust position relative to the valve body to adjust a flow of material through the valve;
a shaft mechanically linked to the valve obstructor;
an actuator that is mechanically linked to the shaft and that is configured to actuate the shaft;
a valve controller configured to transmit an actuation signal to the actuator to actuate the shaft and to thereby achieve a desired position or orientation of the valve obstructor;
a strain sensor disposed on the shaft and configured to: (i) detect a mechanical deformation of the shaft; (ii) generate, based on the detected mechanical deformation, an electrical signal encoded with the measured value for a torque parameter; and (iii) transmit the electrical signal; and
an electric-to-pressure converter communicatively coupled to both the strain sensor and the valve controller, wherein the electric-to-pressure converter is configured to (i) receive the electrical signal; (ii) decode the electrical signal to detect the measured value; (iii) generate a pressure signal encoded with the measured value; and (iv) transmit, to the valve controller, the pressure signal encoded with the measured value for the torque parameter.

2. The control of claim 1, wherein the valve controller is configured to: (i) analyze the measured value for the torque parameter and (ii) cause an alarm to be generated in response to determining that the measured value falls outside a desired range.

3. The system of claim 2, wherein the desired range is determined from an analysis of a history of measured values for the torque parameter.

4. The system of claim 1, wherein the valve controller is configured to receive the pressure signal; determine that the measured value exceeds a threshold; and in response to determining that the measured value exceeds the threshold, transmit an actuation signal to the actuator to cause the actuator to actuate the shaft in a manner that drives the valve obstructor to a safe state.

5. The system of claim 1, wherein the electrical signal is a voltage signal and wherein the electric-to-pressure converter is a voltage-to-pressure converter.

6. The system of claim 1, wherein the valve controller is communicatively coupled to a process controller, wherein the valve controller is configured to generate and transmit the actuator signal based on a command received from the process controller.

7. The system of claim 1, wherein the valve controller includes one or more processors and one or more memories storing a control routine, wherein the control routine, when executed by the one or more processors, cause the valve controller to generate and transmit the actuator signal based on an output of the control routine.

8. The system of claim 1, wherein the actuator signal is a pneumatic signal.

9. The system of claim 1, wherein the valve obstructor is configured to adjust position by rotating around an axis parallel to the shaft to thereby adjust the flow of the material through the valve body.

10. The system of claim 1, wherein the valve obstructor is configured to adjust position by moving in a linear direction to thereby adjust the flow of the material through the valve body.

11. A method for utilizing a measurement of shaft torque in a valve, the method comprising:
detecting, via a strain gauge disposed on a shaft of a valve, a mechanical deformation of the shaft;
generating, based on the detected mechanical deformation, an electrical signal representing a measured value for a torque parameter;
detecting, via an electric-to-pressure converter, the electrical signal;
decoding the electrical signal to detect the measured value;
encoding a pressure signal with the measured value; and
transmitting the pressure signal with the measured value for the torque parameter to a valve controller for the valve.

12. The method of claim 11, further comprising:
analyzing the measured value for the torque parameter;
determining that the measured value falls outside a desired range; and
in response to said determining, generating an alarm.

13. The method of claim 12, wherein the desired range is determined from an analysis of a history of measured values for the torque parameter.

14. The method of claim 11, further comprising:
analyzing the measured value to determine that the measured value exceeds a threshold;
in response to said determining, transmitting, via the valve controller, an actuation signal to an actuator for the valve to cause the actuator to actuate the shaft in a manner that drives a valve obstructor for the valve to a safe state.

15. The method of claim 11, wherein the electrical signal is a voltage signal and wherein the electric-to-pressure converter is a voltage-to-pressure converter.

16. The method of claim 11, wherein the electrical signal is a current signal and wherein the electric-to-pressure converter is a current-to-pressure converter.

17. The method of claim 11, wherein the valve controller is communicatively coupled to a process controller, wherein the method further comprises transmitting the measured value from the valve controller to the process controller.

18. The method of claim 11, wherein encoding the pressure signal with the measured value includes transmitting the pressure signal at a given pressure within a range of 3-15 psi, wherein the given pressure represents the measured value.

19. The method of claim 11, wherein the mechanical deformation is a rotational deformation of the shaft.

20. The method of claim 11, wherein the mechanical deformation is a linear deformation of the shaft.
